(19) United States
(12) Patent Application Publication
(10) Pub. No.: US 2010/0211632 A1
(43) Pub. Date: Aug. 19, 2010

(54) DISTRIBUTION OF MAP MATERIAL

(75) Inventor: Matti Saarinen, Espoo (FI)

Correspondence Address: BROOKS KUSHMAN P.C., 1000 TOWN CENTER, TWENTY-SECOND FLOOR, SOUTHFIELD, MI, 48075, US

(73) Assignee: WHATAMAP.COM OY, Espoo (FI)

(21) Appl. No.: 12/675,895

(22) PCT Filed: Jun. 18, 2008
(86) PCT No.: PCT/FI2008/050372

§ 371 Date: Mar. 1, 2010

(30) Foreign Application Priority Data
Aug. 30, 2007 (FI) 20070659

(51) Int. Cl. G06F 15/16

(52) U.S. Cl. 709/203

(57) ABSTRACT

A method for distributing map material in situations where there are many different kinds of maps of the area. The location of the user of a terminal device is positioned by a positioning method and the maps presented to the user are then selected based on the location. The user selects one or more of the maps for a closer review and loads the selected maps on the terminal device. Then, the user may be directed by the navigation function of the terminal device.

### FIELD OF THE INVENTION

This invention relates to a method for distributing map applications to a user.

### BACKGROUND OF THE INVENTION

In this patent application, the term mobile terminal device refers to a device with such physical dimensions that it is easy to carry. For example a mobile telephone or a pocket computer is a mobile terminal device in the sense of the present application.

In this patent application, the term distribution refers to a means of providing for the user a way of acquiring an application to a mobile terminal device. This way may be for example one Internet link or a number of them which the user may select to install the application.

Various map applications are publically available for and loadable on mobile terminal devices for free or for a charge. The map applications typically include a map of one destination. The maps are typically distributed to users by text messages; by sending a specific text message to a known number, the user acquires a hyperlink which he may select to install said map application. The numbers to which the text messages that order the application are sent are often promoted in the destinations with physical advertisements. Also other distribution channels are available, but these distribution channels often require some preliminary information for loading the application. Most often, this preliminary information is the number to which the text message of a specific format should be sent.

However, sometimes it is difficult to acquire this preliminary information. For example, the map application of a tourist attraction and distribution information for it may be advertised by the entrance of the tourist attraction on a physical billboard. However, if the user has walked past the entrance of the tourist attraction without noticing this advertisement, he does not have the preliminary information required for loading the map application.

Patent publication WO02/075593 describes a method of searching for maps from a database, wherein the information associated with the database is based on the coordinates the map is associated with. JP5052929 describes a method in which a route to a stopover is searched based on location information from a GPS device and illustrated on the display of a device, and the total distance to the stopover and then via the routes between the stopovers up to the final destination is calculated. However, neither of the systems of these reference publications provides a solution to the problem in which there are a number of possible map alternatives and the user does not have any information about which map he would need.

### SUMMARY OF THE INVENTION

This invention aims at solving the above-mentioned problem by a method for distributing map applications without any requirements of preliminary information for the users.

The present invention is characterized in that the method comprises determining the location of the user, sending the determined location to a server, identifying the maps located in the vicinity of the determined location on the server, providing for the user a list of the identified maps and sending a map to the user based on the selection made by the user.

One embodiment according to the present invention, relating to a server application, comprises receiving the location of the user of the terminal device on a server, identifying the maps located in the vicinity of the determined location, providing for the user a list of the identified maps and sending a map to the user based on the selection made by the user.

The method is based on a software to be installed on a mobile terminal device, the software communicating via a data line with a computer server. Information about the maps that can be loaded is stored on this server. This information includes the geographical coordinates of the map so that a list of the maps which include specific geographical coordinates can be requested from the server.

When the user wishes to load a map application of the area in which he is located at the moment, the software installed on the mobile terminal device determines the present geographical location of the user by utilizing a GPS or other device or method and sends to the server a query of the maps which include the present location of the user. The server then sends to the mobile terminal device information about the known map applications which include the present location of the user.

After this, the software installed on the mobile terminal device provides for the user a list of the map applications which include the map on which the user is presently located. If the user selects an application, the software starts to load and install this application.

An advantageous feature of the invention is that the user is provided with a complete list of the maps which are relevant to him and include his location and are loadable, and that to this end, the user does not necessarily need to know his location, if his present geographical location can be determined with a GPS or other device.

Normally, the available maps are indexed according to the area or a specific theme they represent. However, there are many situations where it is difficult or impossible to search for a map by a name or other search term. Even if the map listing could be scrolled by the mobile device arranged by the name or a theme, the person who is in need of the map does not often have the information about the name of the place, and entering the place name is slow and cumbersome with the limited interface of a mobile device. If the place is foreign or uses a completely different set of characters, for example in the case where a western tourist is staying in Japan, it is impossible to understand or even write down the place names, and therefore the map cannot be searched for and selected. Thanks to the invention, the person in need of a map does not have to know anything about the geography of his location to be able to acquire a list of the relevant maps. A further advantage of the invention is that as new and different types of maps become available, they can be searched for by the location information, so that there is no need of searching specifically for them for example by new search terms associated with them.

Furthermore, it is possible to make even quite accurate conclusions about the intended use of the map based on the location. Often, maps that are suitable for quite different purposes are available for an area, such as extensive general maps, more detailed maps representing a small area, or maps indicating specific landmarks which are characteristic of the area in addition to or instead of the conventional landmarks. For example, a map that could be needed in an amusement park area is most likely a map representing the venue and the related services, and not a general map of the entire city. Thanks to the invention, it is possible to compile the map listing in such manner that the most likely needed maps are concluded from the geographical location of the person in need of the map, and these are presented to the user first.

A second example of a special map representing an area is a map that represents the slopes of a downhill skiing centre or other terrain with differences in altitude. A map selected by the location may be selected to specifically represent that side of for example a fjeld or a mountain where the person in need of the map is at that moment. This type of map which represents a slope corresponding to a location is often more useful than a map depicting the entire area, because it is not possible to clearly and graphically portray all slopes simultaneously with the map of the entire area.

Furthermore, one example of the usefulness of the invention are temporary events, such as exhibitions, concerts or other outdoor events not depicted by the general maps representing the area due to their temporary nature. Thanks to the invention, in such event a visitor is able to easily find the map specifically representing the venue, since an updated list of the maps is stored on the server and the user is provided with a list of the maps associated with his location, such as for example the exhibition area.

Another example of a special map which is conveniently provided specifically by the location are line maps for public transport and other traffic maps. It is often necessary to find a map of the transportation vehicles departing from the present location, for example a map depicting the surroundings of a nearest railway or subway station. Thanks to the invention, such map may be provided for the user directly, without the condition that he should be aware of what transportation means are available nearby.

### LIST OF FIGURES

FIG. 1 presents one method according to the invention,

FIG. 2 presents one system according to the invention.

### DETAILED DESCRIPTION OF THE INVENTION

In the following section, one preferred embodiment of the invention in which the user of the invention is a person having access to a terminal device provided with a telecommunications link is described in detail. The telecommunications link of the device is used for connecting the device to a server in a telecommunications network. A person skilled in the art appreciates that such devices and servers may be implemented in many different ways which are not described herein. One very preferred means of application is a mobile telephone provided with a modern packet-switched telecommunications link and capable of communicating with servers in the Internet. Furthermore, to utilize the invention in the best way possible, the location of the terminal device must be determined with sufficient accuracy. Typically, this is arranged with a GPS receiver. However, other positioning methods are suitable as well, and, in many cases, positioning by the telecommunications network is also sufficient from the standpoint of the present invention.

In the present example, the user is located for example in a modern holiday resort where it is possible to engage in many different forms of physical activities and do shopping. The area may encompass for example a skiing centre with slopes and trails, a golf course, outdoor recreation trails, a spa and a shopping centre with a restaurant complex. For all the above-mentioned items there exists an irregular map which is not necessarily on scale. Such map enables better orientation in the resort. Furthermore, a conventional topographic map may be available for the area. It should be noted that all of the above-mentioned maps are not necessarily automatically available at the same time because the demand of the maps varies according to seasons. For example, the demand of the maps for a skiing centre overlaps partly with that for a golf course.

Assume that the user of this example is downhill-skiing in the skiing centre and needs a slope map and a map of the restaurants and other possible recreational activities located in the area.

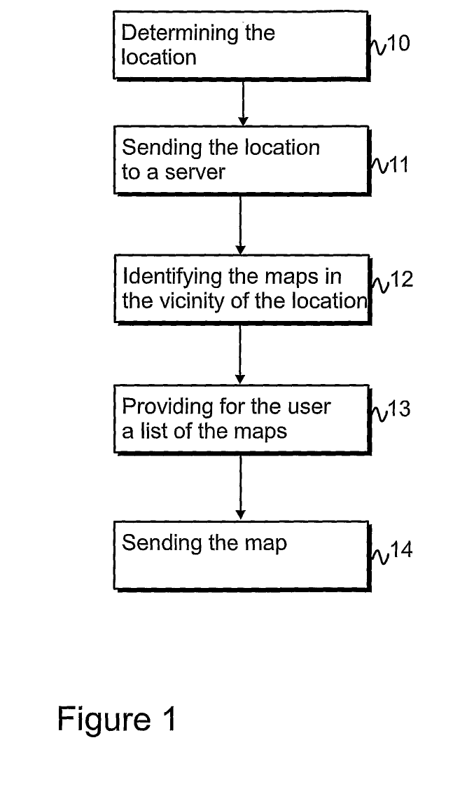

FIG. 1 explains the progress of one method according to the invention. First, the user selects the map service from his mobile telephone. The map service determines first the location of the user, step 10. Then, the determined location is sent to a server via a telecommunications link, step 11. The server identifies the maps in the vicinity of the location based on the location information, step 12. The vicinity may be defined in many different ways, depending on the application. It may be defined for example based on the distance, or for example as a selection that returns five maps nearest to the location, or only the maps including said location. The vicinity may also be defined on the server. For example, in the case of the holiday resort, the server may contain information according to which the area where the services of the holiday resort are located is defined as the vicinity of the holiday resort. In this case, the server checks first the definition of the vicinity and then selects all maps over the area of the vicinity. Furthermore, maps may be selected according to season. The user of this example was downhill-skiing in the skiing centre, so the golf course is probably not open. Thus, it is possible to define the vicinity as encompassing for example a map of the shopping centre, a slope map of the skiing centre and an outdoor recreation map. The user is provided with a list of these maps, step 13. Finally, the user selects one or more of the maps to be loaded on the terminal device, step 14. The terminal device may be arranged to store these maps, and, each time a corresponding process restarts, the terminal device may check whether the map version available is the same as that stored on the terminal device. Preferably, the service is used in this manner with the previously stored maps as well. When the service detects that the user selects from the vicinity a map that is already stored in the mobile telephone and there is not a more recent version available for the map, the map may be displayed immediately. It is also possible to provide navigation services by utilizing the map and the location information. For example, if the user wishes to go to a specific restaurant, the present service may load the maps which are the most useful for easy navigation.

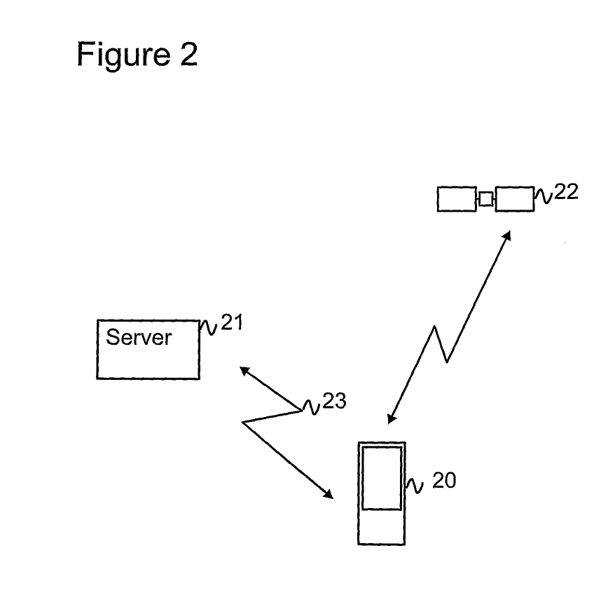

Preferably, the present invention is implemented as a software product operating in the system according to FIG. 2. The software product is installed on a mobile telephone 20. The software product is arranged to contact the server 21 of a service provider, on which server all available maps are stored. Typically, the connection is established via a wireless communication network 23, but the network may also be fixed when a computer is used. In more advanced applications, the mobile telephone may be arranged to use several servers simultaneously. To position the user, the software product uses a satellite positioning device included in or connected to the mobile telephone, which positions the location of the mobile telephone using satellites 22.

The invention is not limited merely to the exemplary embodiments referred to above; instead many variations are possible within the scope of the inventive idea defined by the claims.

1. A method for distributing map material, characterized in that the method comprises the steps of:
determining the location of a user;
sending the determined location to a server;
identifying the maps located in the vicinity of the determined location;
providing for the user a list of the identified maps; and
sending a map to the user based on the selection made by the user.

2. The method according to claim 1, characterized in that said maps comprise regular and/or irregular maps.

3. The method according to claim 1, characterized in that the maps including the determined location are identified

4. The method according to claim 1, characterized in that the user is provided with a list of the identified maps based on a user defined profile.

5. The method according to claim 1, characterized in that the location of the user is determined by a satellite positioning device.

6. The method according to claim 1, characterized in that the location of the user is determined using positioning based on a mobile telephone network.

7. The method according to claim 1, characterized in that the user is directed to the selected destination.

8. A system for distributing map material, the system comprising:
a terminal device;
a telecommunications network; and
a server;
characterized in that the system is arranged to execute the method according to claim 1.

9. A software product for receiving map material, characterized in that when executed in a data processing device, the software product is arranged to execute the following steps:
determining the location of a user;
sending the determined location to a server;
receiving from the server a list of the maps located in the vicinity; and
displaying a map to the user based on the selection made by the user.

10. The software product according to claim 9, characterized in that said maps comprise regular and/or irregular maps.

11. The software product according to claim 9, characterized in that the location of the user is determined by a satellite positioning device.

12. A method for distributing map material on a server, characterized in that the method comprises the steps of:
receiving the location of the user of a terminal device on the server;
identifying the maps located in the vicinity of the determined location;
providing for the user a list of the identified maps; and
sending a map to the user based on the selection made by the user.
